(19) United States
(12) Patent Application Publication
(10) Pub. No.: US 2009/0267466 A1
(43) Pub. Date: Oct. 29, 2009

(54) PRIMARY ENCLOSURE FOR ELECTRIC POWER METERS

(75) Inventors: Gregory L. Zook, Toledo, OH (US); Ronald Balzer, Canton, OH (US); Dan Bertovich, E. Palestine, OH (US)

Correspondence Address: YOUNG BASILE, 3001 WEST BIG BEAVER ROAD, SUITE 624, TROY, MI, 48084, US

(73) Assignee: METER DEVICES COMPANY, INC., Canton, OH (US)

(21) Appl. No.: 12/363,176

(22) Filed: Jan. 30, 2009

Related U.S. Application Data
(60) Provisional application No. 61/048,351, filed on Apr. 28, 2008.

(51) Int. Cl. A47B 81/00; A47F 5/00; A47B 96/06; E05B 1/00; H01F 27/06

(52) U.S. Cl. 312/223.6; 211/134; 248/250; 16/110.1; 336/65

(57) ABSTRACT

A primary enclosure for electric power meters includes at least one shelf for supporting an instrument transformer. Slide mounts are mounted to the interior of the enclosure and to the shelf for slidably supporting the shelf for movement between a first use position in which the shelf and the transformer carried by the shelf are contained entirely within the interior of the enclosure and a second extended position wherein the shelf extends at least partially through an opening in a wall of the enclosure for servicing of the transformer The shelf can include shelf brackets attachable to the slide mounts and a transformer adapter plate to which the transformer is mounted prior to attaching the adapter plate to the adapter shelf to the shelf brackets.

### CROSS REFERENCE TO CO-PENDING APPLICATION

This application claims priority benefit to the filing date of co-pending U.S. Provisional Patent Application Ser. No. 61/048,351, filed on Apr. 28, 2008, the entire contents of which are incorporated herein by reference.

### BACKGROUND

Large electric power users frequently require a primary current transformer and voltage transformer enclosure as part of the primary electric power distribution network to the user's facility in order to reduce the high primary voltage to a lower voltage which can be easily metered. The enclosures may be in an underground vault, a padmount or pole mounted.

Due to the typical 15 KV to 36 KV voltage levels typical in such primary padmount enclosures, the current transformers and the voltage transformers are necessarily large. When it becomes necessary to swap out a current transformer or voltage transformer from the front of the enclosure for repair, upgrading, maintenance, etc., difficulties are encountered due to the tight spaces within the enclosure and the weight of the transformers themselves. Danger to the utility service person is also a potential problem since the transformers are typically swapped out and reinstalled in the enclosure while power continues to be supplied through the enclosure to the customer.

It would be desirable to provide a primary padmount enclosure for electric power meters which addresses these problems found in existing primary padmount enclosures.

### SUMMARY

An electrical primary power transformer apparatus includes an enclosure having a closable opening, a shelf disposed within the enclosure and adapted for supporting at least one current or potential transformer, and slide mount means, disposed within the enclosure, for slidably mounting the shelf in the enclosure for movement between a first position wherein the shelf is contained entirely within interior of the enclosure and a second position where the shelf extends at least partially through the opening in the enclosure.

The apparatus can include a second shelf disposed within the enclosure and vertically spaced from the first shelf. A separate slide mount is provided for the second shelf for slidably mounting the second shelf within the enclosure for movement between the first and second positions.

In one aspect, the shelf includes shelf brackets fixed to the slide mounts and a transformer adapter shelf. The transformer is attached to the adapter shelf prior to affixing the adapter plate to the shelf brackets when the slide mounts are moved to the exteriorly extended position relative to the enclosure.

The primary enclosure for electric power meters enables current and/or potential transformers to be moved to an easily accessible position for installation and maintenance. The primary enclosure also minimizes danger to the service person since the transformer which is being serviced is spaced from many of the power conducting components within the enclosure.

### BRIEF DESCRIPTION OF THE DRAWING

The various features, advantages, and other uses of the present padmount enclosure will become more apparent by referring to the following detailed description and drawing in which:

FIGS. 1A and 1B are left side and right side perspective views of a primary padmount enclosure;

FIG. 2 is a front elevational view of the deadfront in the padmount enclosure;

FIG. 3 is a partial, enlarged, perspective view of the front corner of the enclosure showing the interior frame structure;

FIG. 4 is a front elevational view of the interior of the padmount enclosure with the front doors and wiring removed;

FIG. 5 is a cross sectional view generally taken along line 3-3 in FIG. 2;

FIG. 6 is a partial, enlarged, perspective view of the slide mechanism for a transformer shelf;

FIG. 7 is a partially broken-away, perspective view of the interior of the enclosure;

FIG. 8 is a partial perspective view showing one of the transformer shelves in the extended servicing position;

FIG. 9 is a perspective view of another aspect of a primary padmount enclosure showing the instrument transformer bushing side of the enclosure with the doors in an open position;

FIG. 10 is a perspective view of the opposite side of the enclosure shown in FIG. 9, with the opposite doors in an open position;

FIG. 11 is a elevational view of the interior of another aspect of a padmount enclosure with the doors in an open position;

FIG. 12 is a bottom perspective view of the transformer adapter shelf shown in FIG. 9;

FIG. 13 is a top exploded perspective view of the transformer adapter shelf and transformer;

FIG. 14 is a perspective view of the slide mechanism shown in the extended second position;

FIG. 15 is an enlarged, partial front elevational view of the slide mechanism;

FIG. 16 is an enlarged, partial, perspective view showing the attachment of one end of the slide mechanism shown in FIG. 15 to the enclosure;

FIG. 17 is a perspective view showing the installation of the transformer adapter shelf on the extended slide mechanism;

FIG. 18 is a bottom perspective view depicting the slide mechanism, the transformer adapter shelf and the transformer in the first position within the interior of enclosure;

FIG. 19 is perspective view of a lower shelf in the enclosure depicted in the extended transformer installation position with the shelf locks in a released position; and

FIG. 20 is perspective view showing the lower shelves in the extended transformer installation position with the shelf locks in a deployed, locked position.

### DETAILED DESCRIPTION

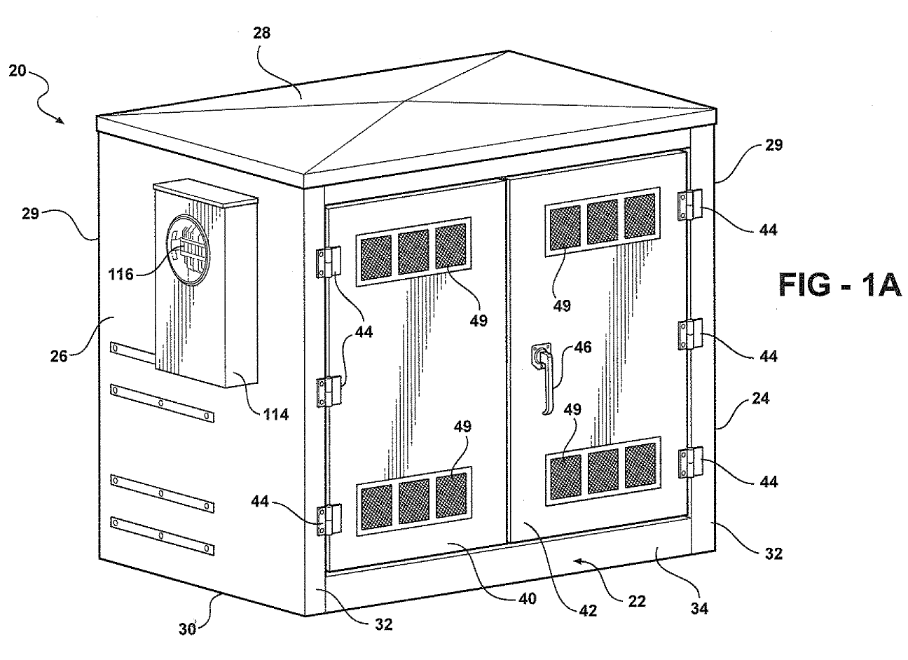

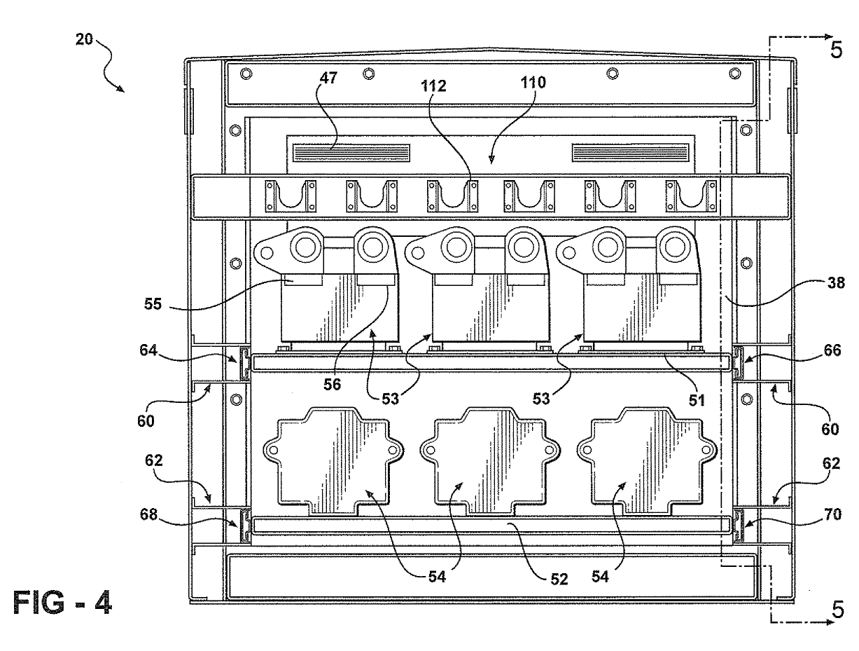

Referring now to FIGS. 1A-8 of the drawing, there is depicted a primary padmount enclosure 20 suitable for use as a primary enclosure for carrying current transformers and voltage or potential transformers in the primary electric power distribution network between the electric power utility and an electric power user.

Although the enclosure 20 is shown as being a padmount enclosure, it will be understood that the following description applies equally to underground or vault-mounted enclosures, and pole-mounted enclosures.

In the following description, the terms “top”, “bottom”, “left”, “right”, “front” and “back” have their normal meanings when the enclosure 20 is placed in a typical mounting position on a pad, in a vault, or on a pole. Further, the terms “front” and “back” or “rear” are taken to the normal entry point for access to the components mounted in the interior of the enclosure 20.

The enclosure 20 defines a compartment having a front wall 22, opposed sidewalls 24 and 26, a top wall 28, a back or rear wall 29, and a bottom 30.

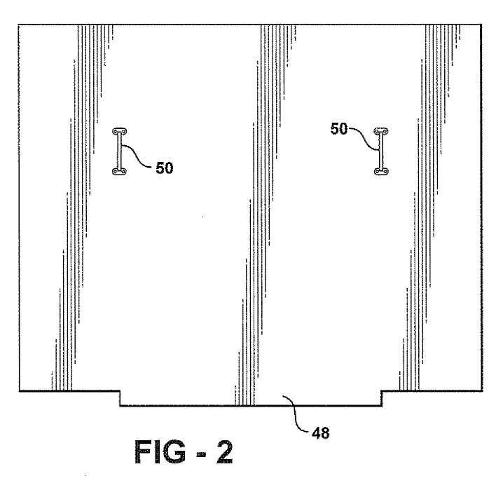

As depicted in FIG. 3, the sidewalls 24 and 26, with only sidewall 26 being shown, have a main panel section with side flanges 32 and a bottom edge 33 which are bent out of the plane of the main portion of the sidewall 26. The flanges 32 and 33 form surfaces to which lower horizontal frame members, all denoted by reference number 34, are fixed at opposed ends, such as by fasteners, particularly nuts and bolts, welding, etc. The lower horizontal frame members 34 also include a bottom retainer bracket 35 which forms a recess for receiving a dead front panel or shield as described hereafter

Interior structural members, such as horizontal strips 37 and a vertically extending strip 39, are fixed to the sidewalls 24 and 26 by bolts to provide structural support for the enclosure 20.

Although FIG. 3 depicts only the structure along the front wall 22 of the enclosure 20, it will be understood that similar structural members and mounting configuration can be provided along the rear wall 29 of the enclosure 20.

The side flanges 32 and the horizontal frame members 34 define front and rear openings which receive a closure, such as two doors 40 and 42, on the front wall 22 of the enclosure 20 and similar doors 41 and 43 on the rear wall 29 of the enclosure 20, which are pivotally mounted by hinges 44 to the vertically extending side flanges 32.

Although one or more front doors 40 and 42 and one or more rear doors 41 and 43 have been described on the enclosure 20, it will be understood that the rear doors 41 and 43 may be replaced by a solid panel or multiple solid panels. In this configuration, the rear wall panel(s) are removable to enable the shelves, described hereafter, to be moved to the extended or outward position.

A lock mechanism and handle 46 may be employed to lock the front doors 40 and 42 in the closed position shown in FIG. 1 and to allow access to the interior of the enclosure 20 only to authorized service personnel.

The lock mechanism 46 includes an interior mounted linkage having a pivotal plate coupled to the handle 46. Rods extend vertically from the plate along the free end of the door 42 and engage apertures formed in the horizontal frame members 34 to latch the door 42 in the closed position when the handle 46 is pivoted to the closed position shown in FIG. 1. A latch plate coupled to the linkage engages an aperture in an inner surface of the door 40 to latch the door 40 in the closed position.

Pivotal movement of the handle 46 in a counter-clockwise direction to allow opening of the door 42 pivots the linkage thereby retracting the rods from the apertures in the horizontal frame members 34 to allow the door 42 to be pivoted to an open position. The pivotal movement of the latch plate coupled to the linkage disengages the latch plate from the door 40 allowing the door 40 to also be pivoted to an open position.

By way of example only, a similar lock and handle mechanism 46 is provided on the rear doors 41 and 43 of the enclosure 20. The lock and handle mechanism 46 can be provided on one of either rear door, such as the door 41 diagonally opposite from the door 42, by way of example.

One or more screen plates 47 may be disposed inside of louvers 49 formed in each door 40 and 42 to allow heat generated by the transformer mounted within the interior of the enclosure 20 to escape.

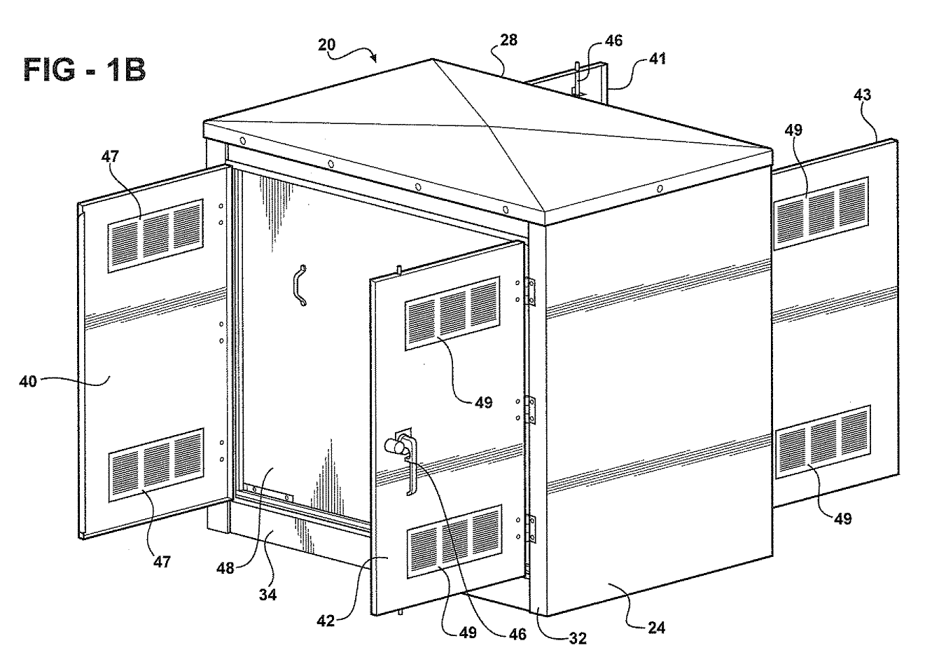

As shown in FIG. 2, a dead front panel 48 is mounted within the enclosure 20 immediately behind the front doors 40 and 42 and, optionally, behind any rear door 41 and 43 provided on the rear wall 29 of the enclosure 20.

The dead front panel 48 is formed of an electrically insulating material, such as a suitable plastic. The panel 48 can have a centrally located aperture to allow viewing of the interior-mounted components without removing the dead front panel 48 from the enclosure 20. Alternately, the entire dead front panel 48 can be formed of a transparent, electrically insulating material. One or more handles 50 are mounted on the dead front panel 48 to allow the dead front panel to be removably installed between the vertical sidewall 26 and lower horizontal frame member 34 of the enclosure 20 seated within the bottom retainer bracket 35 and supported by a lower frame member 37.

As shown in FIGS. 2, 4, and 5, at least one shelf, with two shelves being shown by example, such as a first or upper shelf 51 and a second or lower shelf 52, are movably disposed within the interior of the enclosure 20. Each of the first and second shelves 51 and 53 defines a planar member with depending side edge flanges. The first or upper shelf 51 supports a plurality, such as three current transformers 53; while the second or lower shelf 52 supports a plurality, such as three voltage or potential transformers 54. The current transformers 53 and the voltage transformers 54 are provided in a set of three current 53 and three potential transformers 54 consistent with a three-phase electrical service to a customer.

Line and load connections 55 and 56 on the current transformers 53 receive the utility company's power cables, which is the case of the padmount enclosure 20, are typically underground cables. Similarly, wire connections are made between terminals on the voltage transformers 54 and electric power meters, power monitoring devices, voltage or potential taps, etc., external to the enclosure 20.

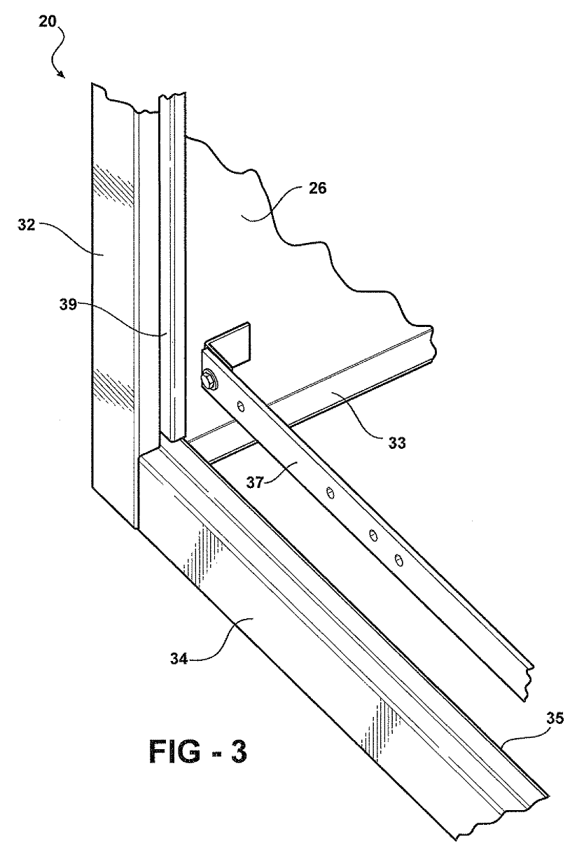

As shown in FIG. 4, each of the transformers 53 and 54 is removably secured, such as by threaded fasteners, nuts and bolts, etc., to the respective shelf 51 and 53. A mounting plate may extend from one end of each transformer 51 or 52 and receive the fasteners to secure the transformers 53 and 54 to the respective shelves 51 and 52.

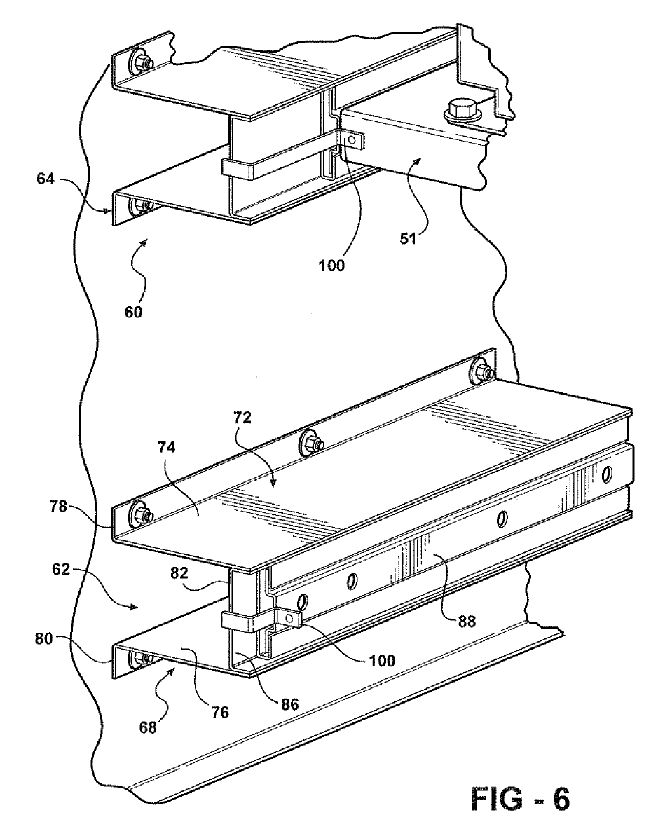

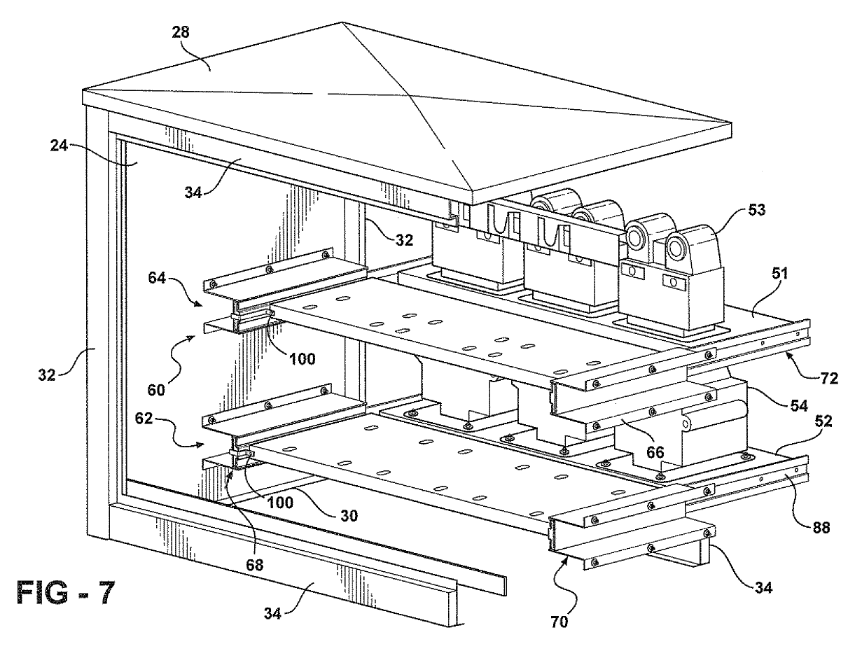

Slide mounts 60 and 62, which may be formed of at least one or a pair of identical slide members 64 and 66 associated with the first or upper shelf 51 and slide members 68 and 70 associated with the second or lower shelf 52, are mounted to the sidewalls 24 and 26 of the enclosure 20 and to the shelves 51 and 53 to allow the first and second shelves 51 and 52 to be easily moved from a first use position contained entirely within the interior of the enclosure 20 and a second, extended or service position shown in FIGS. 7 and 8 where the transformers 53 and 54 mounted on the first and second shelves 51 and 52, respectively, are located outward of the rear wall 29 of the enclosure 20 and at least a portion of each shelf 51 or 52 is positioned exteriorly of the interior of the enclosure 20 for easy servicing, repair, replacement or reinstallation, and associated wiring connections.

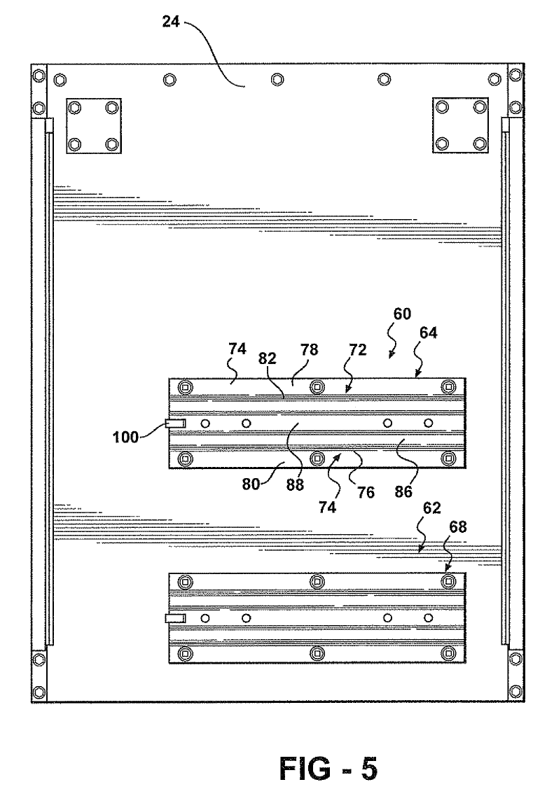

Each of the slide members 64, 66, 68, and 70 may be identically constructed and formed of a U-shaped channel member or bracket 72 formed of opposed sidewalls 74 and 76 terminating in outwardly extending mounting flanges 78 and 80, respectively, which receive fasteners for securing the channel member 72 to the sidewalls 24 and 26 of the enclosure 20, and a central or endwall 82 extending between one end of the sidewalls 74 and 76. The endwall 82 may be an integral part of the sidewalls 74 and 76, all formed of a single piece of bent or formed metal. Alternately, the endwall 82 may be a separate member, such as a U-shaped channel member shown in FIG. 6 which is welded or otherwise secured to space pins of the sidewalls 74 and 76.

In one aspect, each slide member 64, 66, 68 and 70 includes at least one slider fixed to one of the sidewalls 24 or 26 and the side edges of the shelf 50 or 57 and slidably disposed with respect to the other of the sidewalls 24 or 26 and the side edges of the shelf 50 or 51. For example, each slide member 64, 66, 68, and 70 can be a two-part slider formed of an inner member 86 slidably coupled to the endwall 82 of the channel member 72 and longitudinally extendable with respect to the channel member 72. The inner member 86 may have a generally flat endwall, a pair of sidewalls extending from opposite edges of the endwall, and a pair of inward extending flanges having spaced inner edges which define a slot extending along the length of the inner member 86 for receiving fasteners used to secure the outer member 88 to the side flanges of the shelves 51 or 52.

The two-part slider forming each slide member 64, 66, 68, and 70 also includes an outer member or strip 88 having a longitudinally extending raised boss with two outwardly extending side flanges mounted within the inner member 86 and movably coupled thereto, with the boss extending through the slot between the spaced inner ends of the flanges of the inner member 86 and the side flanges of the outer member 88 slidably engaging the side channels formed within the inner member 86. The boss has spaced apertures for receiving fasteners to secure the inner member 86 to a side edge of one of the shelves 51 or 52

A tab 100 is secured at one end to each of the shelves 51 and 52. The tab 100 is bent between opposed ends so that the opposed end engages the endwall 82 of the channel member 72 when the slide members 64, 66, 68 and 70 are in the second position. The tab 100 functions as an outward stop limit to further movement of the attached shelves 51 or 52 when the shelves 51 and 52 are being moved from the first position back to the second position.

A similar stop may be provided on the slide members 64, 66, 68, and 70 to limit extension of the slide members 64, 66, 68 and 70 and the attached shelves 51 and 52 to the second position.

In use, the first and second shelves 51 and 52 can be moved to the second position for installation of the transformers 53 and 54 on each shelf 51 and 52 by means of fasteners. The wiring connections between the external electric power primary distribution network electric power meters, power monitoring equipment and other auxiliary power use accessories which are typically mounted external from the enclosure 20, are then made to the transformers 53 and 54.

The first and second shelves 51 and 52 are then urged rearward into the enclosure with each slide member 64, 66, 68, and 70 telescopingly collapsing on it until the shelves 51 and 52 and the transformers 53 and 54, respectively, are disposed completely within the interior of the enclosure 20 in the first use position. The rear doors 41 and 43 of the enclosure 20 may then be closed and the lock mechanism 46 engaged to secure the enclosure 20. If the enclosure 20 does not have any rear doors 41 and 43, the rear panels are then re-secured to the enclosure 20.

If any of the transformers 53 and 54 needs to be serviced, removed or reinstalled in the enclosure 20, the doors 40 and 42 are opened and one of the shelves 51 or 52 pulled outward through the opening in the rear wall 29 of the enclosure 20 formed by the open doors 41 and 43 until the shelf 51 or 52 reaches the second servicing position shown by way of example in FIGS. 7 and 8.

It will be understood that cable management features may be provided within the enclosure 20 to provide a sufficient length of wires to enable the transformers 53 and 54 to be easily moved between the first and second positions without binding, impediment, etc.

As shown in FIG. 4, a rack 110 is mounted within the enclosure 20. The rack 110 has a strip-like configuration with bent ends which are secured to the sidewalls 24 and 26 of the enclosure 20 by fasteners. Individual park stands 112 are fixed on the rack 110 at spaced intervals and serve to hold or park the utility power cables when the cables are not connected to the current transformers 53.

Referring back to FIG. 1, a housing 114 may be mounted on one of the sidewalls, such as sidewall 26, of the enclosure 20. The housing 114 can be a watthour meter socket housing which a socket 116 has formed of jaw contacts and terminals for receiving a plug-in watthour meter, not shown. The terminals and jaw contacts are connected to the current transformers 53 and the voltage transformers 54 mounted within the enclosure 20 for metering electric power supplied to the customer.

Although not shown in FIG. 1, a plurality of meter test switches are also mounted in the housing 114 and coupled to the current and potential transformers 53 and 54 for electrically connecting the transformers 53 and 54 into or out of the power distribution circuit during repair, installation, etc. The housing 114 or meter socket can be, for example, a Series 3000 meter socket sold by Meter Devices, Inc., of Canton, Ohio. Aligned apertures in the backwall of the housing 114 and the sidewall 26 of the enclosure 20 carry an electrically insulating bushing for passing electrical wires between the socket 120 and any test switches and the current and potential transformers 53 and 54 in the enclosure 20.

It will also be understood that the housing 114 and associated meter socket and/or meter test switches may be mounted completely separate or spaced from the enclosure 20.

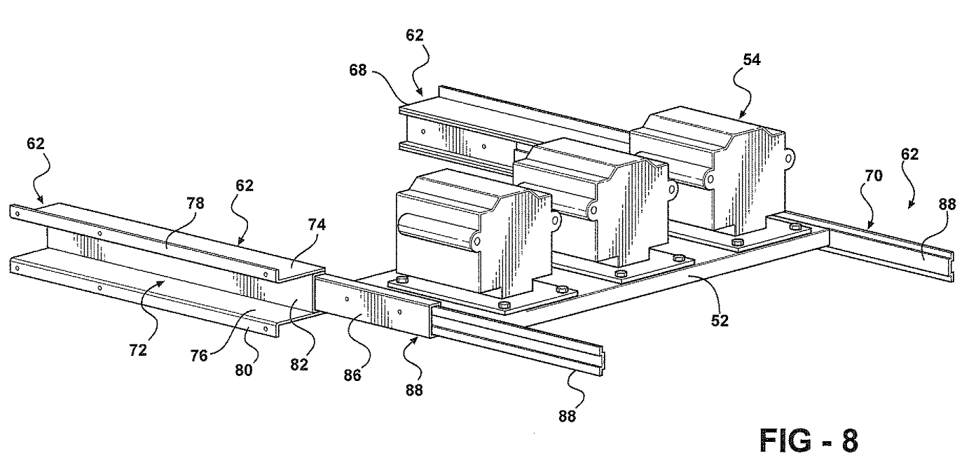

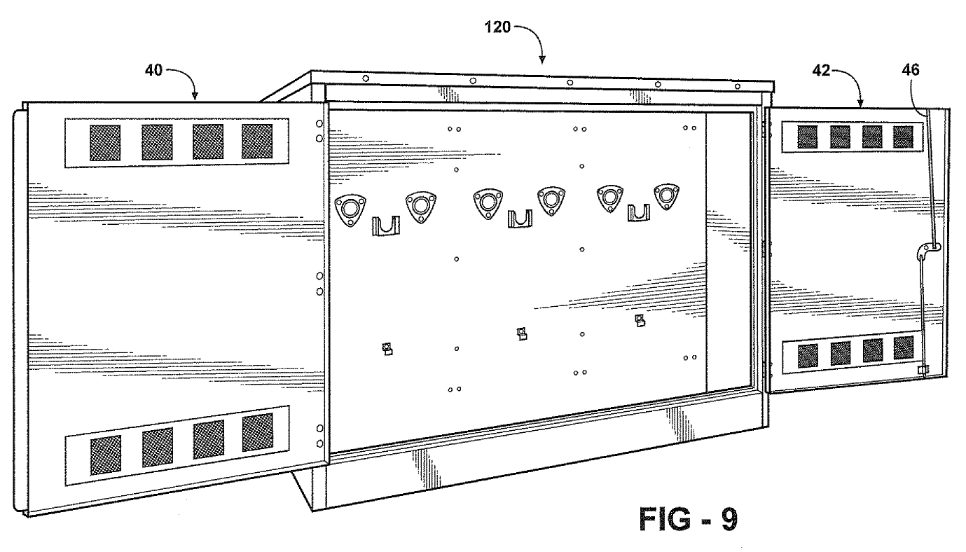

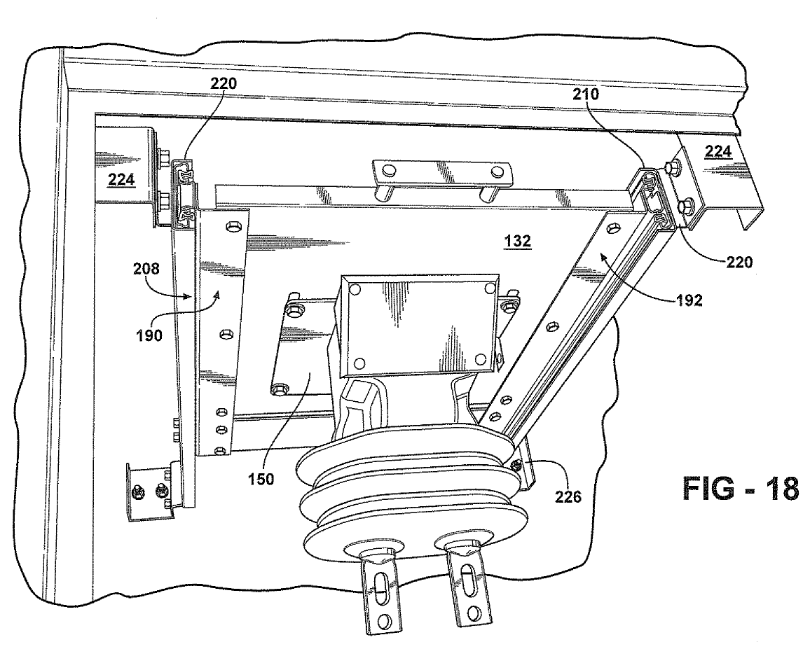

Referring now to FIGS. 9-20, there is depicted another aspect of a padmount enclosure 120. The enclosure 120 is substantially similar to the enclosure 20 and shares the same overall frame and door construction. Therefore, it will be understood that the prior description of the construction of the enclosure 20, including the doors, door handles and locks, vents, etc., applies equally to the structure of the enclosure 120.

The enclosure 120 defines a compartment having a frontwall 122, opposed side walls 124 and 126, a top wall or roof wall 128, a back or rear wall 129, and a bottom wall 130. The enclosure 120 has opposed openings formed by the edges of the side walls 124 and 126, the top wall 128, the front wall 122 and the rear wall 129. One or more front doors, similar to doors 40 and 42 for the enclosure 20, and one or more rear doors, similar to doors 41 and 43 for the enclosure 20, may also be provided in the enclosure 120 to close the front located opening and the rear opening. A lock mechanism and handle, similar to the lock mechanism and handle 46 in the enclosure 20 may be employed to releasibly lock the front doors and the rear doors in a closed position as well as to enable the front and rear doors to be opened to allow access to the interior of the enclosure 120.

In this aspect, the enclosure 120 includes at least one shelf 132, 134 adapted for receiving one or more instrument transformers, such as current transformers 53 or voltage transformers 54. The shelves 132 and 134 each include a transformer adapter shelf 140 and shelf supports or brackets 190 and 192.

Three shelves 132 and three shelves 134 are provided for respectively receiving current transformers 53 and voltage transformers 54 for the three phase electrical service. It will be understood that the enclosure 120 can be configured for a single shelf 132 carrying a single current transformer, and a single shelf 134 for a single voltage transformer 54 in a single phase electrical service installation.

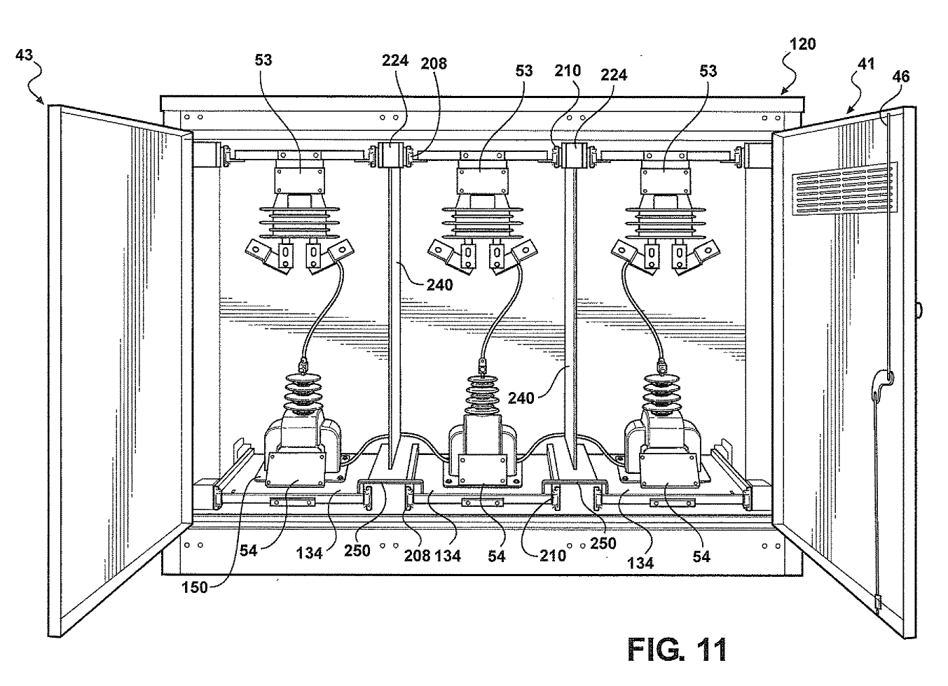

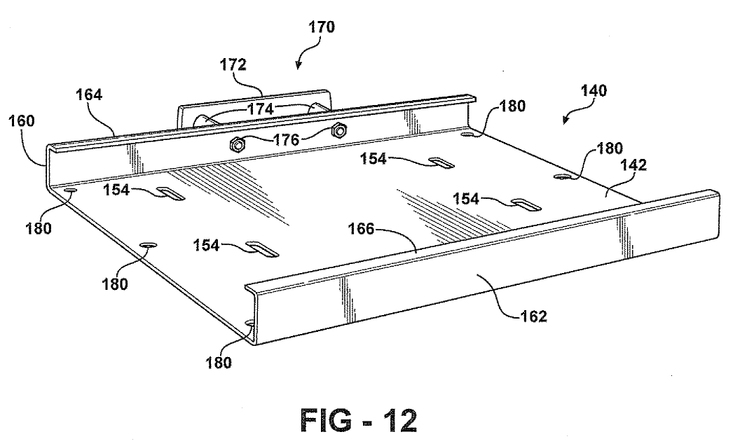

As shown in detail in FIGS. 12 and 13, the transformer adapter shelf 140 is configured for removable installation in the enclosure 120 after an instrument transformer, either one or more current transformers 53 or one or more potential transformers 54, is attached to the adapter plate 140.

Although the following description and illustration of the enclosure 120 shows a single shelf 32 for a single current transformer 53, it will be understood that the enclosure 120 may contain a plurality of shelves 132, each shelf 132 mounting one instrument transformers, either a current transformer 53 or a potential/voltage transformer 54 for individual, separate mounting of each instrument transformer 53, 54 in the enclosure 120. For example, the enclosure 120 may include three upper located shelves 132, each carrying an individual current transformer 53. The voltage transformers 54 in this example may be independently or collectively grouped together on one or more shelves, such as shelves 132 or a shelf 52. Alternatively, one or more shelves 132,134 may be provided for each current transformer 53 and each voltage transformer 54.

In addition, the instrument transformer 53, 54 may be mounted to either surface of the transformer adapter shelf 140 as described hereafter such that the instrument transformer 53,54 extends from a lower surface of the transformer adapter shelf 140 or from the upper most surface of the transformer adapter shelf 140. It is also possible to alternate the orientation of the instrument transformers 53,54 within the enclosure 120 such that one or more of the transformers 53,54 extend from the lowermost surface of one adapter shelf 140 and other instrument transformers are mounted on and extend from an uppermost surface of the adapter shelf 140.

The adapter shelf 140 has a generally planar, sheet-like configuration defining a top surface 142 shown in FIG. 13 and a bottom surface 142 shown in FIG. 12, where the terms “top” and “bottom” are taken with respect to the mounting orientation of the adapter shelf 140 in the enclosure 120.

It should be noted that the transformer adapter shelf 140 is configured for bi-directional mounting within the enclosure 120 such that the bottom surface 144 may be oriented in an upward facing direction thereby acting as a top surface, and the top surface 142 may be oriented in a bottom facing direction.

As shown in FIG. 13, instrument transformers 53 typically carry a mounting bracket or mounting plate 150 which has a plurality of apertures arranged in a particular transformer mounting pattern 53 for receiving fasteners such as bolts, screws, etc. 152 for attaching the instrument transformer 53 to the transformer adapter plate 140. By way of example only, the adapter plate 140 is provided with a plurality of apertures 154 arranged in a selectable aperture arrangement to match the aperture mounting pattern in the transformer mounting plate 150. Four apertures 154 are depicted by way of example only.

A pair of depending rigidity providing side legs 160 and 162 extend from opposite edges of the adapter plate 140. The side legs 160 and 162 transition into inward extending flanges 164 and 166, respectively.

A handle assembly 170 formed of an outer grasping member 172 and one or more sleeves 174 is attached to the flange 160 by fasteners, such as nuts 176, to facilitate movement of the entire shelf 132 relative to the enclosure 120 as described hereafter.

A plurality of apertures 180, with six apertures 180 arranged into sets of three apertures, each are formed along the opposed side edges of the adapter plate 40 and spaced between the flanges 160 and 162. The apertures 180 enable the transformer adapter plate 140 to be removably attached to the shelf brackets 190 and 192.

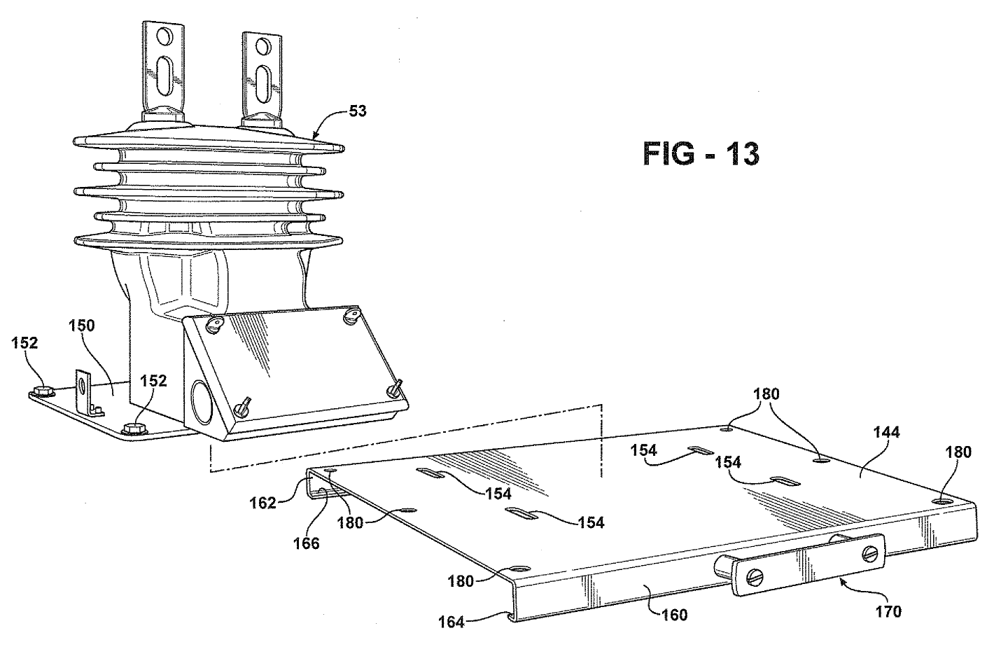

As shown in FIGS. 14, 15, and 16, the shelf brackets 190 and 192 are, by example only, formed as angle brackets with first and second generally perpendicularly disposed legs 194 and 196 for the shelf bracket 190 and legs 198 and 200 for the shelf bracket 192.

The legs 196 and 200 of the shelf brackets 190 and 192, respectively, are secured to the outer slide member 212 of each of the pair of slide assemblies 208 and 210 by suitable means, such as by plurality by longitudinally spaced fasteners, shown by way of example as nuts and bolts, which extend through alignable apertures in the legs 196 and 200, and the outer slide members 212. A rear support or attachment 202 is secured to one end of each of the legs 194 and 200 of the shelf brackets 190 and 192 to maintain the shelf brackets 190 and 192 in a generally parallel orientation so that the mounting apertures 180 on the transformer adapter plate 140 may be aligned with the mounting apertures 204 longitudinally spaced along the legs 194 and 198 of the shelf brackets 190 and 192.

The support 200 may be a separate component fixedly secured to the shelf brackets 190 and 192 by suitable fastening means, such as through the use of fasteners, i.e., the nuts and bolts shown in FIG. 12, welding, etc. The support 200 can also be a one piece integral construction with the shelf brackets 190 and 192 wherein the angle brackets 190, 192 and the support 200 are formed from a single plate and then bent or formed into the illustrated shape.

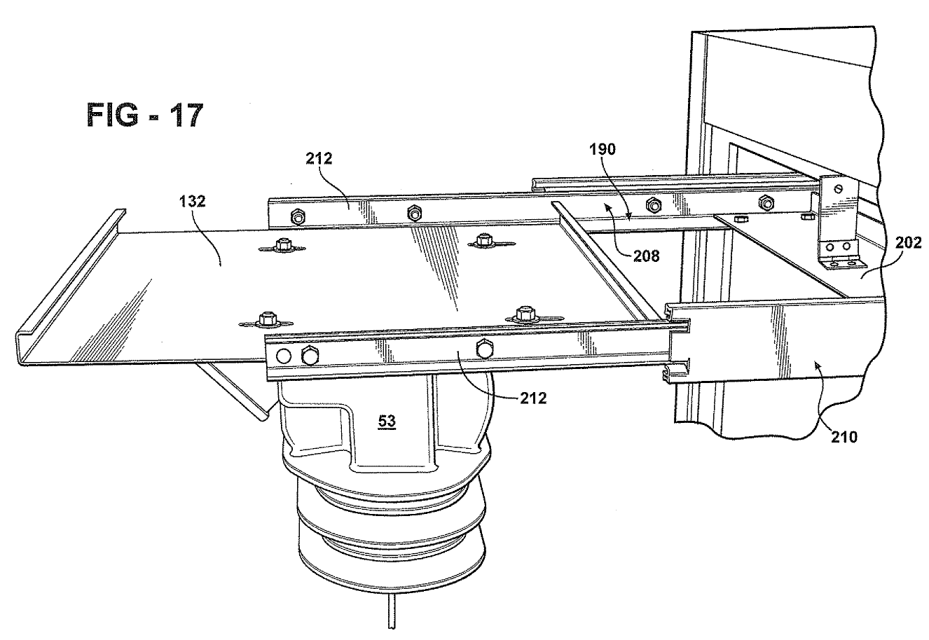

A shelf stop 203 is shown in FIGS. 14 and 17. By way of example, the stop 203 is provided on the upper located shelves 132 which carry the current transformers 53. The shelf stop 203, which may take the form of an L-shaped bracket, is connected by a hinge 204 to the support 200. The hinge 204 enables the stop 203 to be moved from a folded over or lowered position relative to the support 200 to a raised position shown in FIGS. 14 and 17 wherein the stop 203 engages one of the upper walls of the enclosure frame structure to prevent inward sliding movement of the associated shelf 132 when the instrument transformer 53 is being mounted on or removed from the shelf 132.

The stop 203 and hinge 204 can be configured to dispose the stop 203 at a slightly over perpendicular position relative to the support 200 to provide a self locking more secure stop.

At least one and, typically, a pair of slide members 208 and 210 are mounted in the enclosure 120 and secured, as described above, to the shelf brackets 190 and 192. Although any slide or roller mechanism may be employed to provide mobility for the shelf, for example only, the slide mechanisms 208 and 210 are illustrated as having the same construction as the slide members 64, 68, and 70 for the enclosure 20 described above and shown in FIG. 6. Thus, each slide assembly 208 and 210 includes one outer slide member 212 which is a longitudinally telescopedly arranged with respect to an inner slide member 214. The inner slide member is itself longitudinally extendable and retractable with respect to a channel member 216 which is fixedly mounted within the enclosure 120 by means of a slide mount or bracket.

Referring to FIGS. 14-17, it will be noted that the outer slide member 212 and the inner slide member 214 are substantially the same as inner member 86 and the outer member 88 of the slides 64, 66, 68 and 70 in the enclosure 20.

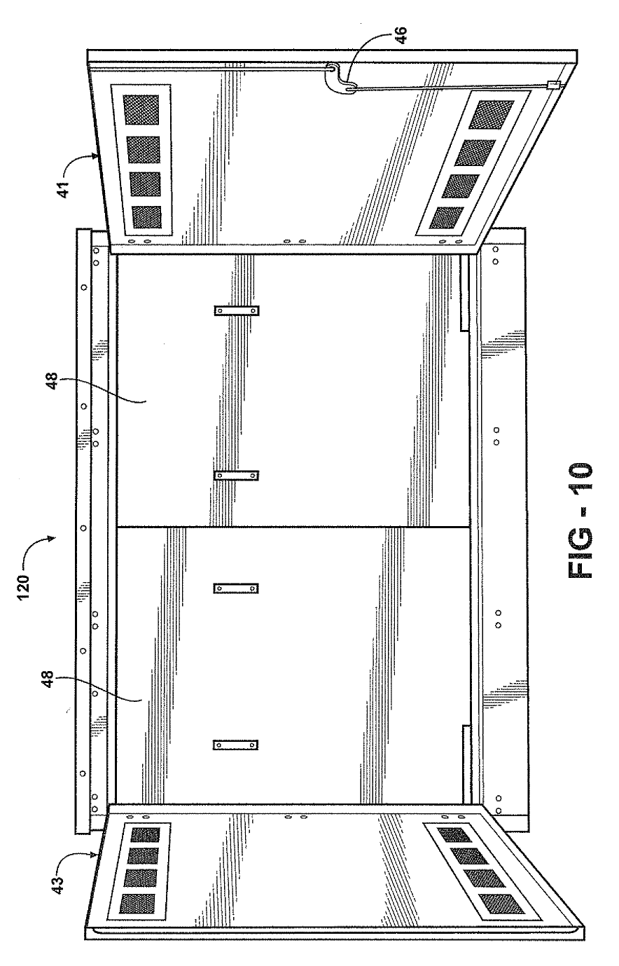

The instrument transformer 53 may be mounted on either the top or bottom surface 142 and 144 as shown in the orientation of the adapter shelf 140 in FIGS. 11, 13, 17 and 18. The entire adapter shelf 140 may then be mounted on the shelf brackets 190 and 192 with the instrument transformer 53 extending downward from lower surface of the adapter shelf 140 or extending upward in a vertical direction within the enclosure 120 from the adapter shelf 140. The downward extending position of the instrument transformer 53 is shown in FIGS. 11, 13, 17, and 18 by way of example, only. This flexibility in the orientation and position of the instrument transformer within the enclosure 120 provides versatility in meeting all required electrical clearances within the enclosure 120.

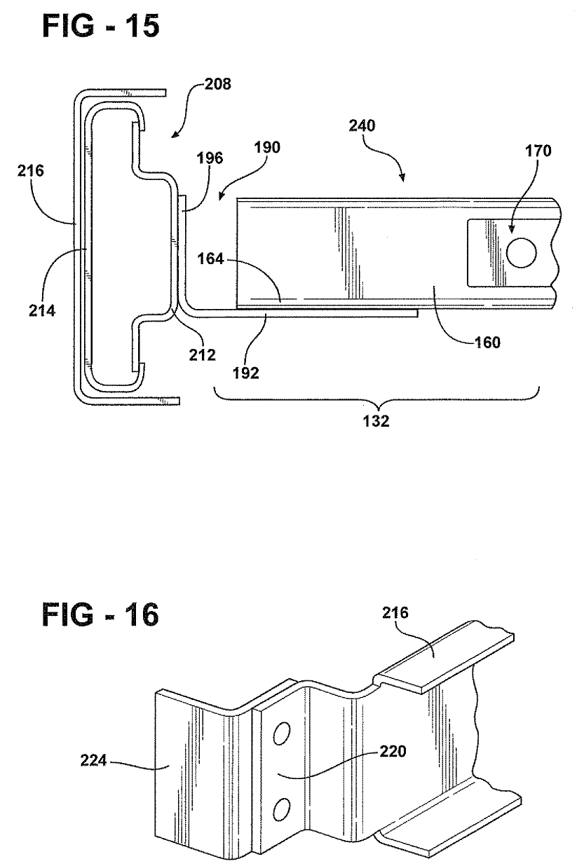

It should also be noted that the channel member 216 of the slide mechanisms 208 and 210 may be mounted to any convenient surface within the enclosure 120, including the sidewalls 124 or 126, the top or roof wall 128, or the rearwall 129. All of these mounting arrangements are shown in at least FIG. 16.

As shown for the channel member 216 of the slide mechanism 208, the longitudinal ends of the channel member 216 are bent outward from the main extent of the channel member 216 to form stepped end flanges 220 and 222. A mounting bracket 224 is securable to the sidewall 124 as well as to the stepped flange 220. Similarly, a different shaped mounting bracket 226 is secured, such as by fasteners, i.e., nuts, bolts and screws to the rearwall 129 of the enclosure 120 as shown in FIG. 16. A similar mounting bracket 226 and end flange 224 is provided on the channel member 216 of the opposed slide mechanism 210 for attaching one end of the channel 216 of the slide mechanism 210 to the rearwall 129 of the enclosure 120.

The forward most end of the channel 216 of the slide mechanism 210 is also bent into a stepped configuration and secured by fasteners, i.e., the nuts and bolts illustrated in FIG. 16, to a suitably formed mounting bracket which, in turn, is secured by fasteners to the top or roof wall 128 of the enclosure 120.

The padmount enclosure 20 or 120 having the movable shelves 51, 52 132 or 134 greatly simplifies the installation and removal of an instrument transformer to and from the padmount enclosure 20 or 120, both during the initial manufacture or assembly of the padmount enclosures 20 and 120 and when servicing or replacing an instrument transformer in the field.

The removable shelves 132 and 134 provided in the enclosure 120 provides further ease of installation and field repair since the instrument transformer can be mounted on the transformer adapter plate 140 outside of the enclosure 120. This facilitates ease of handling and mounting within the typically tight confines of the enclosure 120.

For example, during the initial manufacture of the enclosure 120, or when mounting an instrument transformer in the enclosure 120 when the enclosure 120 is already exposed at the use site, with the slide mechanisms 208 and 210 already mounted within the enclosure 120, then the shelf brackets 190 and 192 fixed to each slide mechanism 208 and 210 may be pulled outward through the opening in the enclosure 120 to the second extended position shown in FIG. 13.

The instrument transformer having previously been or is then mounted to the adapter plate 140 in the desired upward or downward extending position orientation. The mounting apertures 180 in the adapter plate 140 are then aligned corresponding mounting apertures 204 in the shelf brackets 190 and 192. Fasteners, such as the illustrated nuts and bolts, are then mounted through the aligned apertures to removably secure the adapter plate 140 through the shelf brackets 190 and 192 to the slide mechanisms 208 and 210. The adapter plate 140 is then urged into the interior of the enclosure 120 through use of the handle 170 thereby retracting the slide mechanisms 208 and 210 until the slide mechanisms 208 and 210 as well as the attached adapter plate 140 and instrument transformer 53 reach the first position shown in FIG. 14 in which the instrument transformer 53 is housed completely within the interior of the enclosure 120 in the use position.

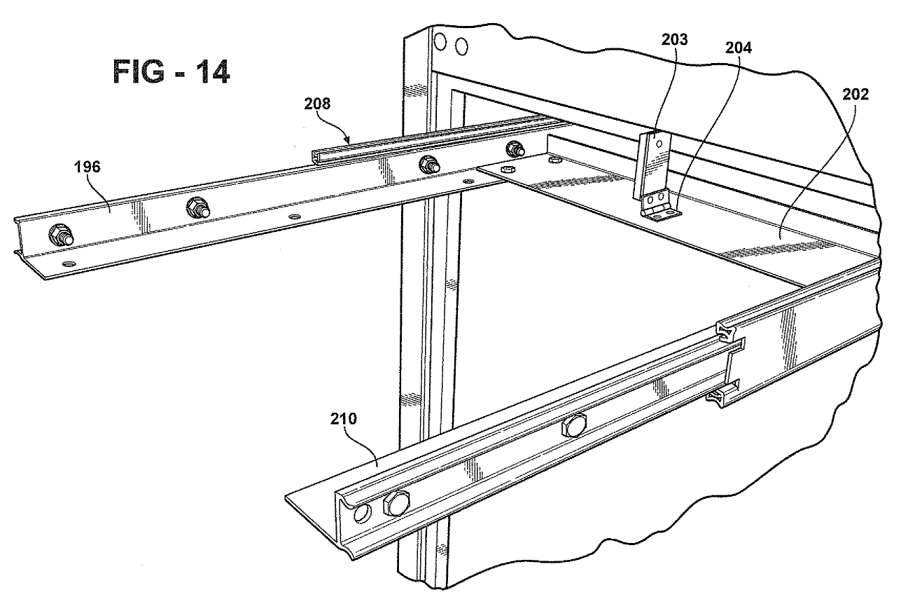

If it becomes necessary to remove or service the instrument transformer 53, a reverse process is employed. After the doors of the enclosure 120 are opened, the service person pulls on the handle 170 to move the instrument transformer 53 mounted on the adapter plate 140 outward to the second access position shown in FIG. 15. The instrument transformer 53 may then be serviced as necessary or the entire instrument transformer 53 and the adapter plate 140 may be detached from the shelf brackets 190 and 192 and removed from the enclosure 120.

Referring now to FIGS. 11, 19 and 20, there are depicted barriers 240 which are located between each current transformer 53 and each voltage transformer 54. The barriers 240 are formed of an electrical insulating material and may be in a form of a generally planar sheet mounted by brackets to the inner walls of the enclosure 120 so that each barrier 240 extends substantially between the top and bottom of the enclosure 120 to separate one pair of current and voltage transformers 53 and 54 from the horizontally adjacent pair or pairs of current and voltage transformers 53 and 54. For higher or voltage enclosures, additional barriers 240 can be installed between the horizontal outer-most current and voltage transformers 53 and 54 and the adjacent enclosure sidewalls 24 and 26.

Shelf stops 250 as shown in FIGS. 11, 19 and 20 for the lower shelves 134, for example. The shelf stops 250 include an inverted U-shaped lock member 252 having a central leg 254 and at least one and typically a pair of depending end legs 256 and 258.

The lock member 252 is mounted on spring strip 260 which is fixed to the channel members 216 of two adjacent disposed sliders 206 and 208. The strip 260 biases the lock member 252 in an upward direction to maintain engagement of the depending end legs 256 and 258 in apertures, such as slots 262, located along one edge of shelf 134 or slots 264 located along the opposite edge of each shelf 134.

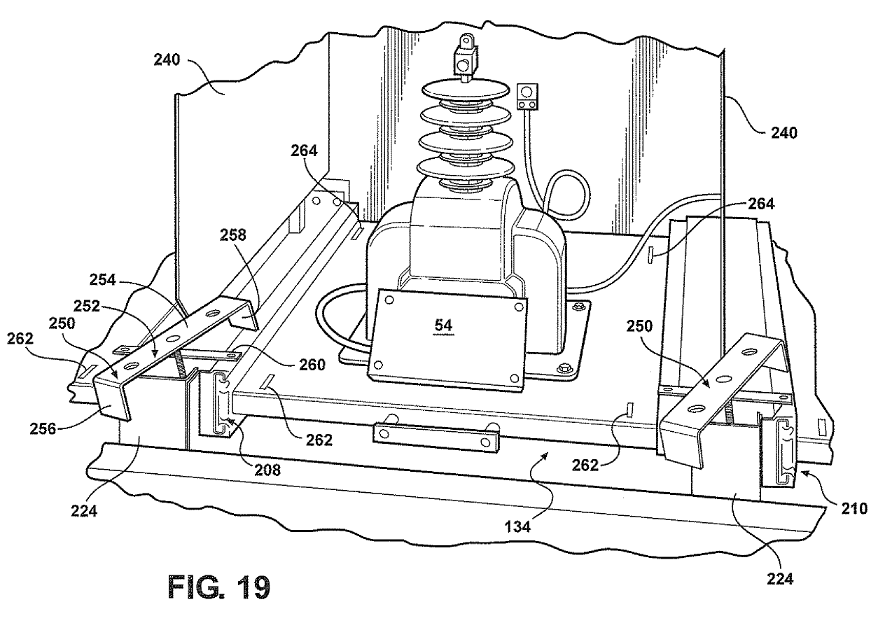

In operation, the lock members 250 will be in the normally locked position shown in FIG. 11 locking each of the shelves 134 in the normal transformer use, first position within the enclosure 120. When it is necessary to install or remove one of the transformers 54, the lock member 252 or membranes are pulled upward disengaging the end legs 256 and 258 from the slots 262. The lock member 252 is then pivoted about the strip 260 to the released position shown in FIG. 19. This enables each shelf 134 to be slid outward to the second transformer installation or removal position or slid back into the interior of the enclosure 120 to the first, transformer use position.

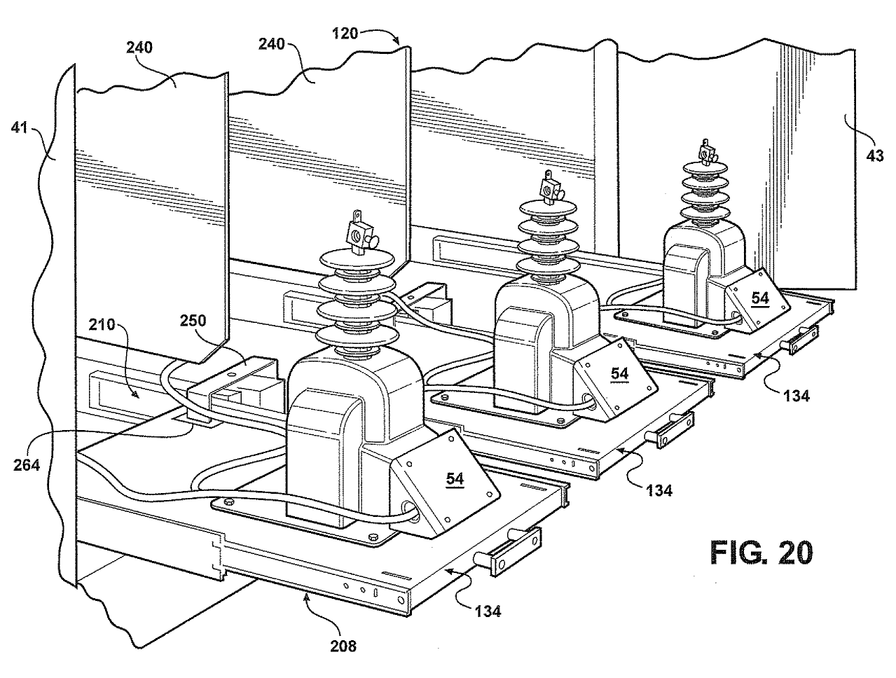

As shown in FIG. 20, when any one or more shelves 134 are deployed in the second outer position for transformer 54 installation or removal from the shelves 134, the lock members 250 are re-pivoted with respect to the respective stripes 260 to engage the end legs 256 and 258 in the slots 264 along the opposite edge of each shelf 134. Each lock member 250 thereby locks one or more of adjacent pair of shelves 134 in the second deployed position shown in FIG. 20.

What is claimed is:

1. An electric primary power apparatus comprising:
an enclosure having an openable and closable panel;
at least one shelf disposed within the enclosure, the shelf adapted for supporting at least one transformer; and
a mount disposed within the enclosure and coupled to the shelf, the mount operative to extensibly mount the at least one shelf in the enclosure for movement between a first position in which the at least one shelf is disposed within an interior of the enclosure and a second position where the at least one shelf extends at least partially outward from the enclosure.

2. The apparatus of claim 1 wherein the at least one shelf further comprises:
another shelf disposed within the enclosure vertically spaced from the at least one shelf; and
a separate mount coupled to the another shelf for extensibly mounting the another shelf within the enclosure for movement between a first and a second position.

3. The apparatus of claim 1 wherein:
the at least one shelf is adapted for supporting at least one of a current transformer and a voltage transformer.

4. The apparatus of claim 1 wherein the mount comprises:
first and second members mounted between opposed side edges of the at least one shelf and the enclosure.

5. The apparatus of claim 1 further comprising:
a stop engageable with the at least one shelf for limiting movement of the at least one shelf in one direction relative to the enclosure.

6. The apparatus of claim 1 wherein the mount comprises:
a bracket fixed to the enclosure; and
one member coupled to the at least one shelf and movably coupled to the bracket.

7. The apparatus of claim 6 wherein the mount further comprises:
a second member slidably disposed between the one member and the bracket and movably coupled to the one member.

8. The apparatus of claim 1 wherein the shelf comprises:
a shelf bracket fixed to the mount; and
a transformer adapter plate removably mountable to the shelf bracket.

9. The apparatus of claim 8 wherein:
the transformer adapter shelf is attached to the shelf brackets by removable fasteners.

10. The apparatus of claim 8 wherein the shelf bracket comprises:
first and second angularly oriented legs, the first leg removably fixable to the mount and the second leg disposed in a position to support the transformer adapter shelf.

11. The apparatus of claim 8 further comprising:
an instrument transformer mounted to one of a top surface and a bottom surface of the transformer adapter shelf with respect to a mounting position of the transformer adapter shelf in the enclosure.

12. The apparatus of claim 8 wherein the transformer adapter plate comprises:
a substantially planar sheet; and
first and second legs extending from opposed side edges of the sheet.

13. The apparatus of claim 12 further comprising:
a handle fixed to one of the legs.

14. An electric primary power apparatus comprising:
an enclosure having a closure;
at least one instrument transformer;
at least one shelf disposed within the enclosure, the shelf adapted for supporting the at least one transformer; and
a mount disposed within the enclosure and coupled to the shelf, the mount operative to extensibly mount the at least one shelf in the enclosure for movement between a first position in which the at least one shelf is disposed within an interior of the enclosure and a second position where the at least one shelf extends at least partially outward from the enclosure.

15. The apparatus of claim 14 further comprising:
a shelf bracket fixed to the mount; and
a transformer adapter plate removably mountable to the shelf bracket.

16. An electric primary power apparatus comprising:
an enclosure having opening and a closure mounted in the opening;
first and second shelves disposed within the enclosure, each supporting at least one instrument transformer; and
first and second mounts coupled between the enclosure and each of the first and second shelves, the first and second mounts extensibly mounting the first and second shelves in the enclosure for movement between a first position wherein the first and second shelves are disposed within an interior of the enclosure and a second position wherein the first and second shelves extend at least partially through the opening in the enclosure.

17. The apparatus of claim 16 wherein the at least one instrument transformer further comprises:
at least one current transformer mount on the first shelf; and
at least one voltage transformer mounted on the second shelf.

18. The apparatus of claim 16 wherein the first and second mounts further comprises:
a bracket fixed to the enclosure;
one member fixed to the at least one shelf and movably coupled to the bracket; and
a second member movably disposed between the one member and the bracket and movably coupled to the one slide member.

19. An electric primary power apparatus comprising:
means for providing an electric primary enclosure with an openable and closable panel;
means for mounting an extensible and retractable mount within the enclosure;
means for providing a shelf adapted for removably supporting an instrument transformer; and
means for mounting the transformer on the shelf when the mount is disposed in a position such that the shelf is exteriorly disposed with respect to the enclosure.

20. A method of mounting an instrument transformer in an electric primary power enclosure comprising the steps of:
providing an electric primary enclosure with an openable and closable panel;
mounting an extensible and retractable mount within the enclosure;
providing a shelf adapted for removably supporting an instrument transformer; and
mounting the transformer on the shelf when the mount is disposed in a position such that the shelf is exteriorly disposed with respect to the enclosure.

21. The method of claim 20 further comprising the step of:
affixing a shelf bracket to each of the mounts;
attaching the transformer to a transformer adapter plate when the transformer adapter plate is detached from the shelf bracket; and
fixing the transformer adapter plate carrying the transformer to the shelf bracket.
